(19) United States
(12) Patent Application Publication
(10) Pub. No.: US 2021/0326014 A1
(43) Pub. Date: Oct. 21, 2021

(54) EXECUTING BACK-END OPERATIONS INVOKED THROUGH DISPLAY INTERACTIONS

(71) Applicant: SAP SE, Walldorf (DE)

(72) Inventor: Sebina Hitzler, Heidelberg (DE)

(21) Appl. No.: 16/853,989

(22) Filed: Apr. 21, 2020

(51) Int. Cl. G06F 3/0484; G06F 3/0482

(52) U.S. Cl. CPC G06F 3/0484; G06F 3/0482

(57) ABSTRACT

The present disclosure relates to computer-implemented methods, software, and systems for performing operations in relation to an image based on an interaction with a user interface element at a user interface displayed on a display device. The image in connection with a label element is provided at a first interface of a user interface application. A first user interaction is received in relation to the label element. In response to determining that the first user is authorized to perform an operation associated with the label element, a second user interface of the user interface application is provided. The operation is defined as authorized for the first user at a back-end logic implemented for the user interface application. A second user interaction with the second user interface is received. The second user interface provides the image in a first operational mode for performing the authorized operation.

### TECHNICAL FIELD

The present disclosure relates to computer-implemented methods, software, and systems for data processing in a platform environment.

### BACKGROUND

Software applications and platforms provide services to end users and customers. For example, e-commerce retail stores may provide services in relation to buying and selling products, such as clothes, household amenities, etc. Software applications include front-end and back-end logic to serve user's requests and to execute implemented operations. Front-end logic may include different user interfaces that can be displayed to provide interaction options and to invoke logic implemented at the back-end. A set of user interfaces may be designed for a particular software application, for example, a human resource management system, an e-commerce website, etc. The user interfaces include images, text, and other user interface elements that organize information and provide interaction options for communication between users and service or product providers associated with the software application.

### SUMMARY

The present disclosure involves systems, software, and computer implemented methods for performing operations in relation to an image based on an interaction with a user interface element at a user interface displayed on a display device.

One example method may include operations such as providing, at a first interface of a user interface application displayed on a display device, an image in connection with a label element; receiving, at the first user interface, a first user interaction in relation to the label element, wherein the first user interaction is a selection performed at a location within an activation screen area at the first interface that is associated with the label element, wherein the first user interaction is performed by a first user; in response to determining that the first user is authorized to perform an operation associated with the label element, providing a second user interface of the user interface application for performing the authorized operation, wherein the operation is defined as authorized for the first user to be performed over the image at a back-end logic implemented for the user interface application; and receiving a second user interaction with the second user interface in relation to the image, wherein the second user interface provides the image in a first operational mode corresponding to the authorized operation, wherein the second user interaction is defined as available for the first user and in relation to the image in the first operational mode, wherein the second user interaction is for performing the operation. Other implementations of this aspect include corresponding systems, apparatus, and computer programs, configured to perform the actions of the methods, encoded on computer storage devices.

Implementations can optionally include that the label element is presented at the first interface as partially overlapping the image. Implementations can optionally include that the activation screen area for the label element includes a screen area, including the image and the label element. The label element may optionally be defined as associated with a plurality of operations at the back-end logic corresponding to different authorization rights defined for a plurality of user of the user interface application

In some instances, the method may further include configuring the label element at the user interface application to be coupled with one or more operations set up at the back-end logic implemented for the user interface application. The label element may be configured to include an image icon corresponding to a default of the one or more operations.

In some instances, the method may further include, based on the received second user interaction, an operation on the image may be executed to change the image and to store a changed image at the back-end logic of the user interface application.

In some instances, the label element as presented at the first interface prior receiving the first user interaction includes a first image icon. The method may further include that in response to invoking the first interface of the user interface application by the first user after executing the second user interaction, the changed image and the label element including a second image icon are presented. The label element may be in active mode to receive user interactions. The second image icon may be associated with a different operation defined at the back-end logic implemented for the user interface application.

Similar operations and processes may be performed in a system comprising at least one process and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. In other words, while generally described as computer implemented software embodied on tangible, non-transitory media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, as well as, from the claims.

### DESCRIPTION OF DRAWINGS

FIG. 1 illustrates an example computer system architecture that can be used to execute implementations of the present disclosure.

FIG. 2 is a group of example images displayed at a user interface and associated with different label elements in accordance with implementations of the present disclosure.

FIG. 3 is a block diagram for example user interfaces of an application providing interactive options for invoking an operation in relation to a displayed image in accordance with implementations of the present disclosure.

FIG. 4 is a block diagram for an example system providing user interactions for invoking operations in relation to displayed images on different user interfaces in accordance with implementations of the present disclosure.

FIG. 5 is a block diagram for an example activation areas defined in relation to displayed images with associated label elements on user interfaces in accordance with implementations of the present disclosure.

FIG. 6 is a flowchart for an example method for invoking operations in relation to displayed images in accordance with implementations of the present disclosure.

FIG. 7 is a schematic illustration of example computer systems that can be used to execute implementations of the present disclosure.

### DETAILED DESCRIPTION

The present disclosure describes various tools and techniques for providing user interfaces of a user interface application where based on user interactions in relation to images and connected label elements, operations implemented at a back-end logic coupled to the user interface application can be invoked and executed for the images.

In some instances, an interface application provides different user interfaces for user interaction. For example, the interface application may be a human resource application, a product catalog, etc. The interface application is coupled to back-end logic providing execution of operations in relation to requested services through the interface application. The user interface application and the back-end logic may be implemented as cloud applications or as on-premise applications. The user interface application can be accessed through a web browser or may be installed as a native application running an operating system at a client device, such as a mobile phone, a tablet, a laptop, etc.

In some instances, a first user interface of the user interface application may be displayed on a display device of a user, where the user interfaces include an image that is connected with a label element. The label element may be defined in relation to the image to correspond to an operation that may be executed over the image. The label element may be a user interface element including an icon image associated with, for example, edit, upload, download, zoom out, or other operation.

In some instances, during interaction with the user interface application, users may request to perform different actions on images that are to be displayed on user interfaces in relation to different processes running at the application and different business scenarios. Different user roles may be associated with different authorization rights to perform actions on images. By providing label elements in relation to the images, an indication of the associated operations that are available for execution for the image may be provided. Further, the displayed label elements may be linked with back-end implemented logic that can be invoked for execution over images through user interface interactions.

In some instances, a request for an operation in relation to an image may be requested through a user interaction at a user interface with one or more label elements connected with the image, and the execution of the operation and logic for the execution may be implemented at a backend application communicatively coupled to the interface application.

In accordance to implementations of the present disclosure, providing images with label elements associated with operations where the logic of the operations is separated from the interface application provides multiple technical advantages including, for example, process execution improvements as operation logic is executed at the back-end application, and system architecture flexibility as operation logic can be adjusted without interfering with the visual presentation of the application. Further, user experience is improved, as the user interface provides indication of the available operations in relation to the displayed images. In such manner, the number of user interactions performed with the application is reduced, allowing resource consumption to be reduced and process efficiency to be improved as fewer user interactions has to be processed.

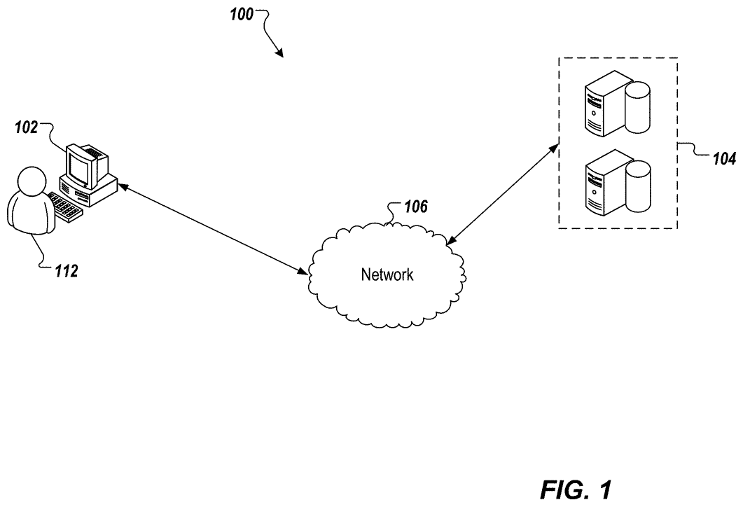

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to, a web server, an application server, a proxy server, a network server, and/or a server pool. In general, server systems accept requests for application services and provide such services to any number of client devices (e.g., the client device 102 over the network 106).

In accordance with implementations of the present disclosure, and as noted above, the server system 104 can host an interface application communicatively coupled to a back-end application to provide services to end users. The back-end application may be connected to a database for storing data in relation to the interface application and the executed services.

In some instances, the server system 104 may host a user interface application that provides different user interfaces to a user where images are displayed. The displayed images within user interfaces of the application may be presented in connection with label elements. A user interacting with user interfaces of the interface application may perform selections on areas of the screen in relation to the presented label elements to request operations to be performed on displayed imaged. In response, further user interfaces may be displayed in relation to requested operations. The user interfaces may provide interaction options for requesting operations available to the user in relation to images based on interactions with label elements connected to the images.

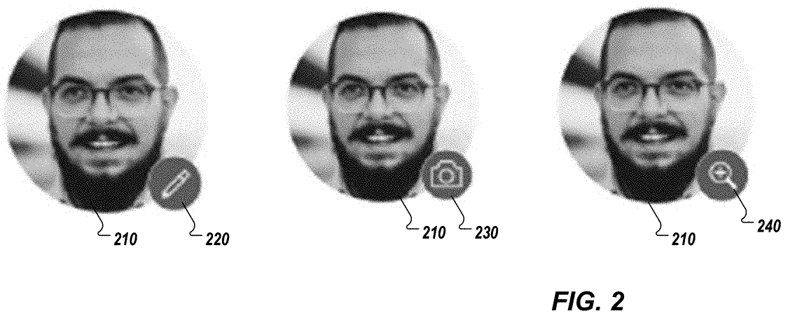

FIG. 2 is a group of example images displayed at a user interface and associated with different label elements in accordance with implementations of the present disclosure.

Depending on the implementation, the image 210 may be displayed in connection with different label elements, such as 220, 230, and 240. The image 210 may be an image displayed as part of a profile of a user at a user interface application, such as a human resources application. The image may be an image of an employee that is displayed at the application, which is used to identify the user. The user profile page of the application includes a user interface that can be viewed by the profile owner, by other employees of the company associated with the human resource application, by company owners, managers, different stakeholders, or by external personnel to other externals to the user's organization or group if the application is exposed to external users, such as partner or clients.

In some instances, based on the different users accessing the user profile page and the process scenario related for previewing that page, different operations may be available for execution by the different users. For example, when an owner of the profile opens his/her user profile page, the user interface may display a profile picture connected with a label element. The label element may be associated with an operation such as editing or replacing of the image. To identify the relationship between an operation and the label element, the label element may include an icon image related to editing operations of user or record data, for example, such as 220, changing the image such as 230, or zooming into or out of the image such as 240.

In another example, when a user opens a profile page of another user, the profile image displayed at the profile user interface may be associated with an operation, for example a zoom out operation, as displayed in relation to label element 240. However, certain operations may be limited for users who are not the profile owner of a page. Therefore, an edit operation may not be provided as available for changing a profile picture of a different user that the profile owner.

In yet another example, there may be application system user roles that may be associated with multiple operations. For example, a system user may be provided with all available options for an image irrespective of whether he is an owner of a profile page. For example, a system administrator may be provided with all available operations for an image defined and implemented at a backend application of an interface application of the company.

In some instances, more than one operation may be associated with a label element, and a user interaction performed with the label element may provide for display options for the different operations associated with a label element. For example, by selecting a label element by a user, an additional interface element may be displayed including an indication for multiple operations, such as edit, zoom, and upload, at the same time. Thus, a user may select one of the multiple options and request an execution of an operation. The different options may be organized in different manner on the user interface. For example, they may be prioritized based on statistics of historic requested operations by a particular user or by a user role of the user requesting the operation.

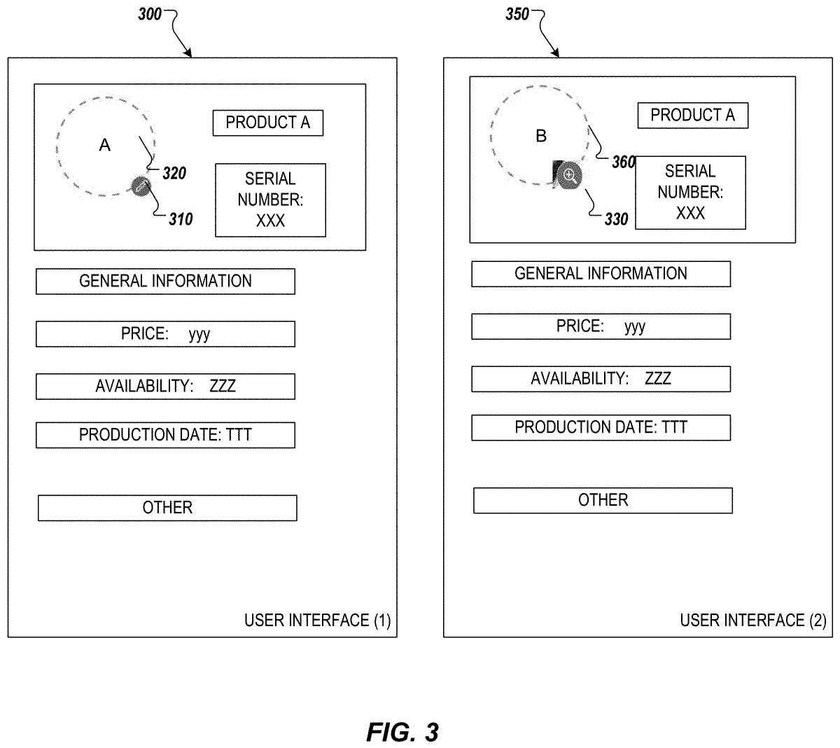

FIG. 3 is a block diagram. For example, user interfaces 300 and 350 of an application provide interactive options for invoking an operation in relation to a displayed image in accordance with implementations of the present disclosure.

In one implementation, the example user interfaces 300 and 350 may be part of an e-commerce product catalog, as discussed in the present disclosure.

The user interface 300 may be an interface presented in relation to Product A that is displayed with an image 320. The image 320 is connected with a label element 310 that indicates an editing operation. The user interface 300 may be configured to provide services to end users in relation to making edits in the content of the user interface 300. For example, a user may interact with the label elements 310 connected with the image 320 to invoke an editing operation. The user interaction may be performed over the label element area on the screen or in the surrounding areas.

In some instances, after an interaction with the image 320, the image 320 may be put into an editing operation mode, the image 320 may be replaced and a new image 360 may be uploaded for the Product A. The user interface 350 may display the product page of product A, where the image that is presented is the new image 360 that was updated to replace the image 320.

In some instances, the new image 360 is presented with a new label element 330 that is different from the label element 310. The new label element 330 may be associated with a zoom out operation.

In some instances, the way of changing operations associated with images in consecutively presented user interfaces as part of execution of an interface application may be based on tracked user interaction history.

For example, it may be determined from statistics generated in relation to user interactions with images related to products at a product catalog that users usually preview images after making changes (e.g. edits or replacing of images). Then, based on such statistics, once an image is edited at one user interface as shown in user interface 300, a second user interface presented after the executed change or edit of the image, may present the image and a connected different operation that the already performed edit operation, e.g., a zoom out operation as shown in user interface 350. The zoom out operation and the edit operation may be both associated with the label element and available for the image. Thus, the ordering of label elements presented to the user on the user interface may be organized based on previous user interaction evaluations.

In some instances, the label element presented in connection to a product image at a product catalog may be associated with multiple operations, where a first default icon image may be presented in the label element. If multiple operations are associated with a product image, the label element may indicate in relation to the default icon image that more operations are provided, for example, by adding a visual indication. For example, a “ . . . ” in close proximity to the presented label element may indicate that the label element is associated with more than the operations related to the default image icon. If a user performs an interaction with the indication presented on the user interface, e.g., the “ . . . ” label element, which is indicative that there are a set of available operations for the product image, a drop down menu may appear that allows the user to select a next operation from a displayed set of label elements.

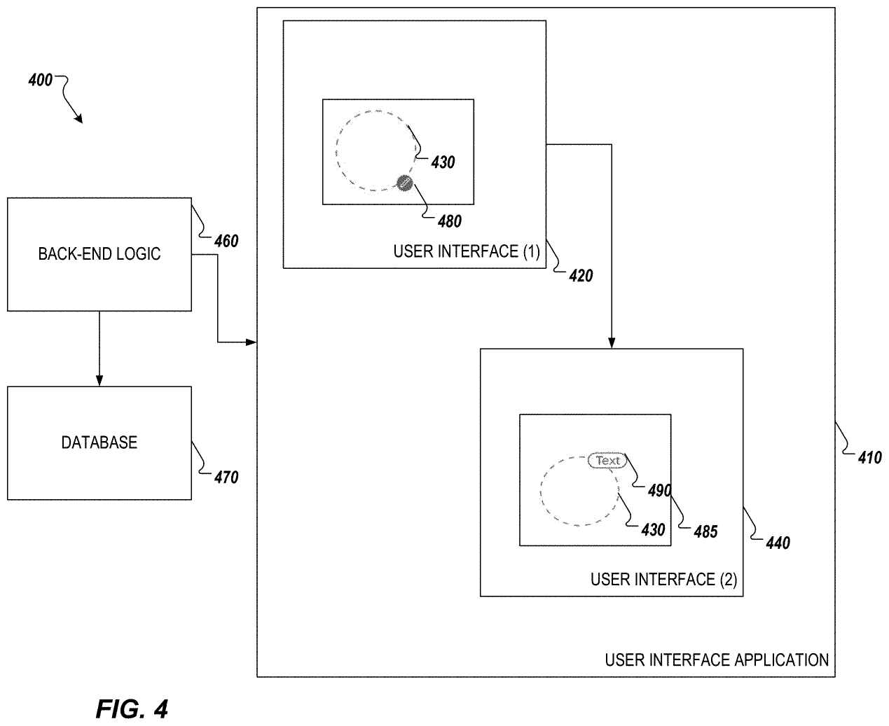

FIG. 4 is a block diagram for an example system 400 providing user interactions for invoking operations in relation to displayed images on different user interfaces in accordance with implementations of the present disclosure.

The system 400 includes a user interface application 410 that is communicatively coupled to a back-end logic 460 and a database 470. The user interface application 410 may be an interface application, including the example user interfaces 300 and 350 as described in relation to FIG. 3. The user interface application 410 may provide different user interfaces to end users. For example, end users may be associated with different roles and corresponding authorization permissions. Based on user permissions, different rights may be provided to different end users to perform operations in relation to presented images at the different user interfaces of the user interface application 410. A user having an administrator role may be provided with permissions to view, edit, delete, and replace images. A user having a role of a buyer may be only provided with permissions to view an image. Further, a user having a role of a product manager may be provided with permissions to view, edit, and delete images. Other configurations and definition of operations and corresponding permissions for performing operations on images may be defined.

The user interface application 410 may be such as the example applications discussed in the present disclosure, including a human resource application, an e-commerce website, a product catalog, etc.

In some instances, a user interface 420 may be displayed for preview by end users of the user interface application 410. The user interface 420 may include different user interface elements, such as text blocks, buttons, icons, images, etc. The user interface 420 includes an image 430 that is connected with a label element 480. The image 430 may be such as those discussed earlier in relation to FIG. 2 and FIG. 3. For example, the image 430 may be a photo image of a user and the user interface 420 may be a profile page of the user.

In some instances, a user interacting with the user interface 420 may select a section on the user interface 420 to perform an operation on the image 430, where the operation is related to the label element 480 associated with the image, i.e. edit operation. The received selection may be performed at a location that is within an activation screen area at the user interface 420 that is associated with the label element 480.

In some instances, after performing of a user interaction within an activation area in association with the label element 480, a second user interface 440 is provided. The second user interface 440 is associated with an operation defined for the label element. The operation is authorized for the user requesting the operation by the interaction. The operation definition and execution logic may be stored at the back-end logic 460 and invoked upon user interaction with the label elements 480 (or the activation area as disclosed herein). The operation logic that is to be invoked may depend on the authorization rights and corresponding permissions for performing operations for the image 430 by the user requesting the operation.

In some instances, the second user interface 440 receives user interaction in relation to the image when the image is in a first operational mode at the second user interface, as presented 485. For example, the first operational mode for image 430 may be an editing mode. Further, after entering the first operation model as shown at 485 and at the second user interface 440, a user may be provided with an option to provide text to be attached to the image and this to update the image by adding the text as a label.

As such, the image may be presented with some additional text information provided by the end user, such as the text 490.

Further, the second user interface 440, the context menu 490 may indicate an “Effects” image operation as an available editing operation to be performed on the image 430. Different types of image editing models may be available for the image 430. The type of available operation may be predefined at the back-end logic 460 and may be displayed to the end user through a series of drop down menus, slide controls or text entry.

For example, a user may edit the image 430 by applying a color enhancing effect on the image 430, or by applying a filter on top of the image 430. Further editing may be also provided as available for the image 430 at the operation model 485.

In some instances, after performing an editing operation on the image 430, the change to the image may be stored through the back-end logic and maintained in the database 470. Therefore, upon subsequent loading of the user interface 420, the image that is to be presented in the place of image 430 would be the image that is stored as edited by a performed editing operation at user interface 440 as discussed.

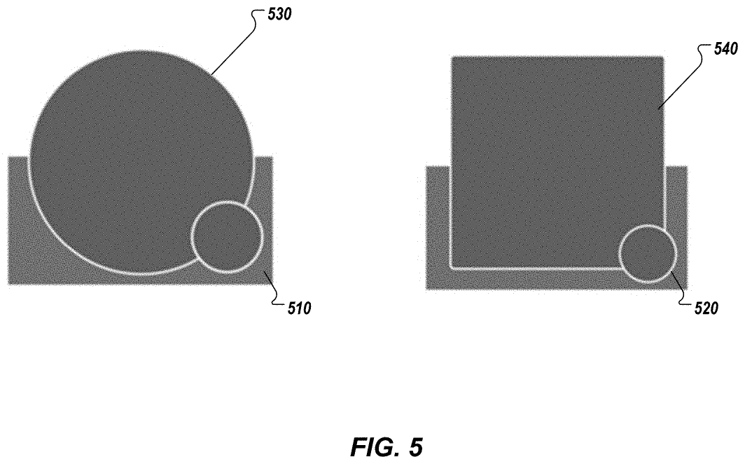

FIG. 5 is a block diagram for an example activation areas defined in relation to displayed images with associated label elements on user interfaces in accordance with implementations of the present disclosure. The activation areas are defined in relation to label elements, such as, the label elements 240 of FIGS. 2, 310 and 320 of FIG. 3.

In some instances, the activation areas are screen areas defined at user interfaces to surround the label elements. They may be configured based on tracking user interaction and preciseness of selection of a user with an input device, such as a mouse, a mobile pen device, etc. When a user selects a location within a defined activation area, the received selection is determined to be associated with the label elements related to the activation area.

In some instances, the image may be presented in a circular or rectangular form as respectively presented as image 530 and 540. The activation area may be defined in relation to the lower half part of the image. The activation area may be defined in a rectangular form encompassing the lower image part or it may include the whole image.

In some instances, the definition of the activation area may be defined based on evaluation of user interactions with user interfaces of particular interface application. In some examples, users may be monitored to determine where they intend to select the screen area when they want to activate an operation related to a label element connected with an image. As different applications has different type of users, the different users may have different preferences and user behaviors. Monitoring user interactions may be utilized and evaluated for improving the user interfaces. By defining activation areas based on evaluation of user interactions with user interfaces and manner of performing selections in relation to label elements, improvement to the user experience when working with an interface application may be provided. Further, load handled by the interface application may be reduced as fewer interactions are to be performed in relation to executing a certain operation by the user.

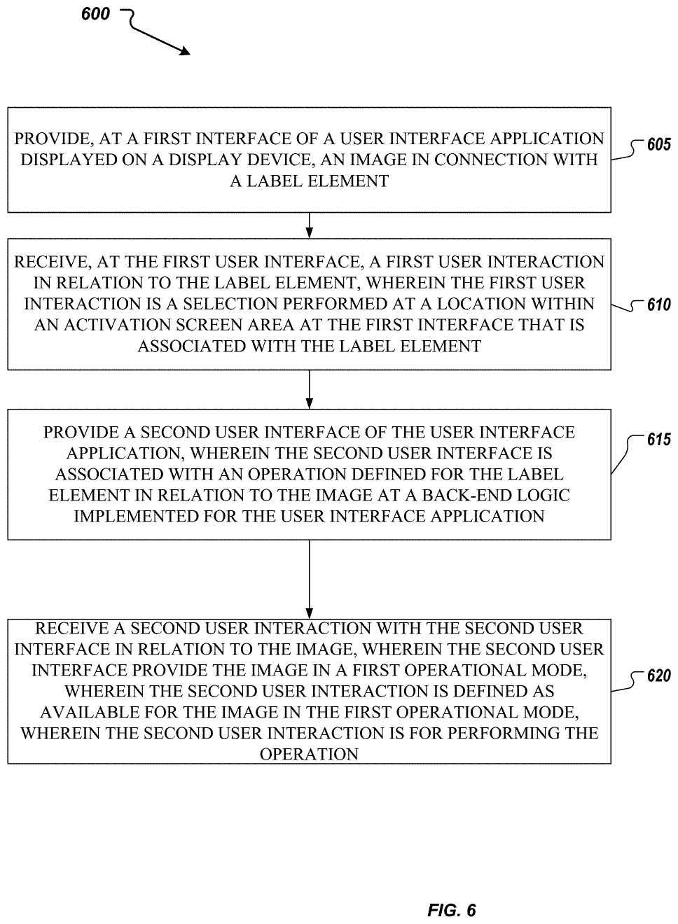

FIG. 6 is a flowchart for an example method 600 for invoking operations in relation to displayed images in accordance with implementations of the present disclosure. The method 600 may be executed at a system, such as the system 400 of FIG. 4, although other suitable systems and components may be used for the implementation.

At 605, an image in connection with a label element is provided at a first interface of a user interface application. The user interface application may be displayed on a display device. The user interface application may be such as the user interface application 410 of FIG. 4. The user interface application may expose user interfaces for user interaction. The first interface may be such as the user interface 300 of FIG. 3 or user interface 420 of FIG. 4.

In some instances, the first interface includes an image, such as a picture of a product, a profile photo of a user, or other type of image. The first interface includes the image and a connected label element to the image. The label element may be, for example, the label elements presented and discussed in relation to the description of FIG. 2 and FIG. 3. The label elements may include icon images that relate to associated operations that may be invoked through the user interface and performed for the image.

In some instances, the label element is presented at the first interface as partially overlapping the image. For example, the image and the label element may be presented in circle or rectangular form and the label elements may be overlapping a portion of the circular or the rectangular image, as displayed at FIG. 5.

In some instances, the first user interaction is received from a first user of the user interface application who is defined as authorized for performing the operation defined for the label element in relation to the image. For example, the user interface application is a product catalog and the first user is a product manager maintaining data in relation to products provided through the interface application. The user interface application includes different user interfaces where product information for the different products is provided.

At 610, at the first user interface, a first user interaction in relation to the label element is received. The first user interaction is a selection performed at a location within an activation screen area at the first interface that is associated with the label element.

In some instances, the activation screen area may be configured at the first user interface to surround the area presenting the image and the connected label element. For example, the activation screen area may be configured as discussed in relation to FIG. 5 and the active area 510 and 520 defined for images 530 and 540.

In some instances, the activation screen area for the label element includes a screen area, including the image and the label element.

In some instances, the label element is configured at the user interface application to be coupled with one or more operations set up at the back-end logic implemented for the user interface application. The operations configured to be associated with the label element may correspond to different permissions. In such a case, when a user interaction is an identifier, the user authorization in relation to one or more operations associated with the label element may be defined. For example, the label element may be associated with an editing operation for the image that may be executed according to editing logic implemented at the back-end logic. The label element may be configured to include an image icon corresponding to a default of the one or more operations. A corresponding operation and an operational mode for the image may be invoked based on the authorization of the user requesting the first user interaction.

In some instances, the user interfaces displayed by the interface application may change the displayed icon image within the label element according to application logic and the configurations defined at the back-end. For example, some of the operations may be associated with a user of a certain role where other operations may not be available for that role. Therefore, in such manner, the available operations can be displayed based on user authorization right and pushed from the back-end logic.

For example, an owner of a product catalog who accesses an e-commerce interface application be provided with displayed images of products with badges that indicate that the images can be edited, for example, updated to a new version, or marked with a visual tab, for example “Sale” or “Reduced availability.” Such editing options may be provided to an owner of an e-commerce interface application because of his authorization right defined at the front or back-end. However, when a user, such as a customer, opens the e-commerce interface application, and previews a product, a label element to an image of a product from the catalog may include other image icon associated with another operation, such as a zoom out operation used to expand the picture to a relatively larger one.

In some instances, the activation screen area associated with the image and the label element is visually presented on the first interface, for example, with a shadow effect, coloring effect, or other manner of marking the visual presentation of the area in relation to the image that may be distinguishable by an end user to identify a location of the screen to activate an operation associated with the displayed label element.

At 615, a second user interface of the user interface application is provided for display. The second user interface is provided based on the received first user interaction in relation to the label element. The second user interface is associated with an operation defined for the label element in relation to the image. In response to determining that a first user, who performed the user interaction at 610, is authorized to perform an operation associated with the label element, the second user interface of the user interface application for performing the authorized operation is provided.

In some instances, the operation is defined as authorized for the first user to be performed over the image at a back-end logic implemented for the user interface application. The label element may be associated with multiple operations, where based on authorization of the first user, one of the operations is provided for the user at the second user interface.

The label element is defined as related to the operation at the back-end logic implemented for the user interface application. In such manner, when the second user interface is provided, the associated operation with the label element that is selected based on the first user interaction is invoked and the image may be presented in a corresponding operational mode. For example, the image may be provided in an editing mode where multiple effects or shades can be changed. Further, the second interface may present the image in a zooming operational mode, where user interface elements are provided to assist the user to zoom in or zoom out into the image.

At 620, a second user interaction with the second user interface is received in relation to the image. The second user interface provides the image in a first operational mode. The second user interaction is defined as available in the first operational mode. The received second user interaction is for performing the operation provided by the first operational mode for the image.

For example, the first operational mode may be an editing mode defined for the second user interface where an editing operation can be performed on the image, such as executing a visual effect on the image. As another example, the first operational mode may be an editing mode that provides an uploading operation to replace the image as presented in the second user interface with another image that can be uploaded by a user, for example, from his device where the user interface application is rendered.

In some instances, based on the received second user interaction, an operation on the image to change the image is executed. A changed image is stored at the back-end logic of the user interface application. Thus, when the first interface of the interface application is displayed after the change, the image will be displayed as the changed image based on the executed change.

In some instances, the label element as presented at the first interface prior receiving the first user interaction includes a first image icon, and upon invoking the first interface of the user interface application by a first user after executing the second user interaction, presenting the changed image and the label element including a second image icon, wherein the label element is in active mode to receive user interactions, and wherein the second image icon is associated with a different operation defined at the back-end logic implemented for the user interface application.

Further, and in relation to the implementations of the present disclosure, once a particular operation is performed over an image, e.g., image is replaced with a different one through an edit and/or upload operation, once the same user interface, including the image is loaded for preview by a user, another operation may be associated with the displayed label element, for example, zoom out, so the user can preview the image in a bigger size.

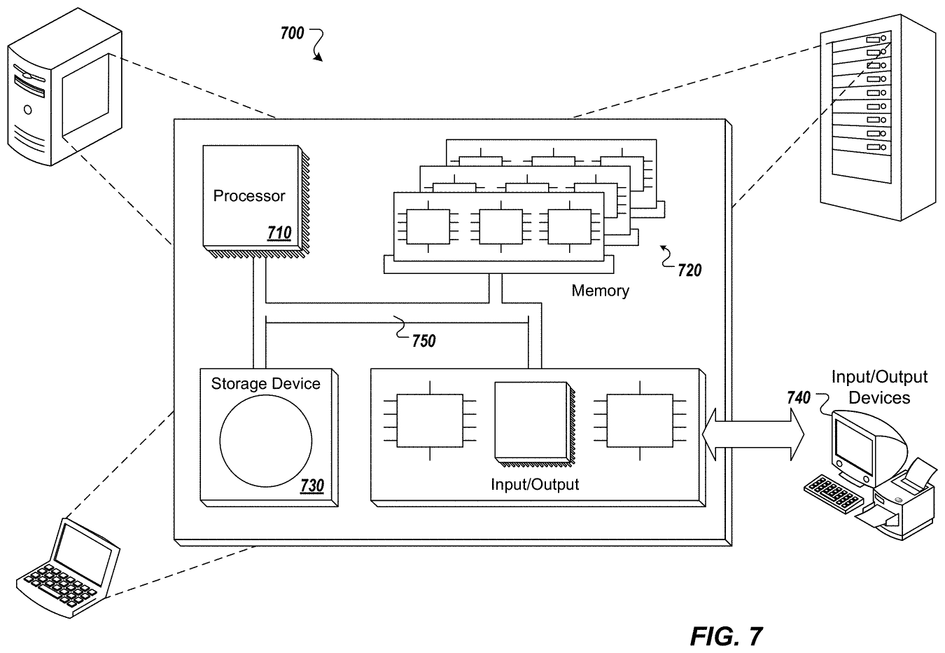

Referring now to FIG. 7, a schematic diagram of an example computing system 700 is provided. The system 700 can be used for the operations described in association with the implementations described herein. For example, the system 700 may be included in any or all of the server components discussed herein. The system 700 includes a processor 710, a memory 720, a storage device 730, and an input/output device 740. The components 710, 720, 730, 740 are interconnected using a system bus 750. The processor 710 is capable of processing instructions for execution within the system 700. In some implementations, the processor 710 is a single-threaded processor. In some implementations, the processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. In some implementations, the memory 720 is a volatile memory unit. In some implementations, the memory 720 is a non-volatile memory unit. The storage device 730 is capable of providing mass storage for the system 700. In some implementations, the storage device 730 is a computer-readable medium. In some implementations, the storage device 730 may be a floppy disk device, a hard disk device, an optical disk device, or a tape device. The input/output device 740 provides input/output operations for the system 700. In some implementations, the input/output device 740 includes a keyboard and/or pointing device. In some implementations, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device, such as a CRT (cathode ray tube) or LCD (liquid crystal display) monitor for displaying information to the user and a keyboard and a pointing device, such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method, the method comprising:
providing, at a first interface of a user interface application displayed on a display device, an image in connection with a label element;
receiving, at the first user interface, a first user interaction in relation to the label element, wherein the first user interaction is a selection performed at a location within an activation screen area at the first interface that is associated with the label element, wherein the first user interaction is performed by a first user;
in response to determining that the first user is authorized to perform an operation associated with the label element, providing a second user interface of the user interface application for performing the authorized operation, wherein the operation is defined as authorized for the first user to be performed over the image at a back-end logic implemented for the user interface application; and
receiving a second user interaction with the second user interface in relation to the image, wherein the second user interface provides the image in a first operational mode corresponding to the authorized operation, wherein the second user interaction is defined as available for the first user and in relation to the image in the first operational mode, wherein the second user interaction is for performing the operation.

2. The method of claim 1, wherein the label element is presented at the first interface as partially overlapping the image.

3. The method of claim 1, wherein the activation screen area for the label element includes a screen area, including the image and the label element.

4. The method of claim 1, wherein the label element is defined as associated with a plurality of operations at the back-end logic corresponding to different authorization rights defined for a plurality of user of the user interface application.

5. The method of claim 1, further comprising:
configuring the label element at the user interface application to be coupled with one or more operations set up at the back-end logic implemented for the user interface application, wherein the label element is configured to include an image icon corresponding to a default of the one or more operations.

6. The method of claim 1, further comprising:
based on the received second user interaction, executing an operation on the image to change the image and storing a changed image at the back-end logic of the user interface application.

7. The method of claim 6, wherein the label element as presented at the first interface prior receiving the first user interaction includes a first image icon, and wherein the method further comprises:
in response to invoking the first interface of the user interface application by the first user after executing the second user interaction, presenting the changed image and the label element including a second image icon, wherein the label element is in active mode to receive user interactions, and wherein the second image icon is associated with a different operation defined at the back-end logic implemented for the user interface application.

8. A non-transitory, computer-readable medium coupled to one or more processors and having instructions stored thereon which, when executed by the one or more processors, cause the one or more processors to perform operations, the operations comprising:
providing, at a first interface of a user interface application displayed on a display device, an image in connection with a label element;
receiving, at the first user interface, a first user interaction in relation to the label element, wherein the first user interaction is a selection performed at a location within an activation screen area at the first interface that is associated with the label element, wherein the first user interaction is performed by a first user;
in response to determining that the first user is authorized to perform an operation associated with the label element, providing a second user interface of the user interface application for performing the authorized operation, wherein the operation is defined as authorized for the first user to be performed over the image at a back-end logic implemented for the user interface application; and
receiving a second user interaction with the second user interface in relation to the image, wherein the second user interface provides the image in a first operational mode corresponding to the authorized operation, wherein the second user interaction is defined as available for the first user and in relation to the image in the first operational mode, wherein the second user interaction is for performing the operation.

9. The computer-readable medium of claim 8, wherein the label element is presented at the first interface as partially overlapping the image, wherein the activation screen area for the label element includes a screen area, including the image and the label element.

10. The computer-readable medium of claim 8, wherein the label element is defined as associated with a plurality of operations at the back-end logic corresponding to different authorization rights defined for a plurality of user of the user interface application.

11. The computer-readable medium of claim 8, further comprising instructions, which when executed by the one or more processors, cause the one or more processor to perform operations comprising:
configuring the label element at the user interface application to be coupled with one or more operations set up at the back-end logic implemented for the user interface application, wherein the label element is configured to include an image icon corresponding to a default of the one or more operations.

12. The computer-readable medium of claim 8, further comprising instructions, which when executed by the one or more processors, cause the one or more processor to perform operations comprising:
based on the received second user interaction, executing an operation on the image to change the image and storing a changed image at the back-end logic of the user interface application.

13. The computer-readable medium of claim 12, wherein the label element as presented at the first interface prior receiving the first user interaction includes a first image icon, and wherein the computer-readable medium further comprises instructions, which when executed by the one or more processors, cause the one or more processor to perform operations comprising:
in response to invoking the first interface of the user interface application by the first user after executing the second user interaction, presenting the changed image and the label element including a second image icon, wherein the label element is in active mode to receive user interactions, and wherein the second image icon is associated with a different operation defined at the back-end logic implemented for the user interface application.

14. A system comprising
a computing device; and
a computer-readable storage device coupled to the computing device and having instructions stored thereon which, when executed by the computing device, cause the computing device to perform operations, the operations comprising:
providing, at a first interface of a user interface application displayed on a display device, an image in connection with a label element;
receiving, at the first user interface, a first user interaction in relation to the label element, wherein the first user interaction is a selection performed at a location within an activation screen area at the first interface that is associated with the label element, wherein the first user interaction is performed by a first user;
in response to determining that the first user is authorized to perform an operation associated with the label element, providing a second user interface of the user interface application for performing the authorized operation, wherein the operation is defined as authorized for the first user to be performed over the image at a back-end logic implemented for the user interface application; and
receiving a second user interaction with the second user interface in relation to the image, wherein the second user interface provides the image in a first operational mode corresponding to the authorized operation, wherein the second user interaction is defined as available for the first user and in relation to the image in the first operational mode, wherein the second user interaction is for performing the operation.

15. The system of claim 14, wherein the label element is presented at the first interface as partially overlapping the image.

16. The system of claim 14, wherein the activation screen area for the label element includes a screen area, including the image and the label element.

17. The system of claim 14, wherein the label element is defined as associated with a plurality of operations at the back-end logic corresponding to different authorization rights defined for a plurality of user of the user interface application.

18. The system of claim 14, wherein the computer-readable storage device further comprises instructions, which when executed by the computing device, cause the computing device to perform operations comprising:
configuring the label element at the user interface application to be coupled with one or more operations set up at the back-end logic implemented for the user interface application, wherein the label element is configured to include an image icon corresponding to a default of the one or more operations.

19. The system of claim 14, wherein the computer-readable storage device further comprises instructions, which when executed by the computing device, cause the computing device to perform operations comprising:
based on the received second user interaction, executing an operation on the image to change the image and storing a changed image at the back-end logic of the user interface application.

20. The system of claim 19, wherein the label element as presented at the first interface prior receiving the first user interaction includes a first image icon, and wherein the computer-readable storage device further comprises instructions, which when executed by the computing device, cause the computing device to perform operations comprising:
in response to invoking the first interface of the user interface application by the first user after executing the second user interaction, presenting the changed image and the label element including a second image icon, wherein the label element is in active mode to receive user interactions, and wherein the second image icon is associated with a different operation defined at the back-end logic implemented for the user interface application.
